(19) United States
(12) Patent Application Publication
(10) Pub. No.: US 2010/0023890 A1
(43) Pub. Date: Jan. 28, 2010

(54) Listing for received messages

(76) Inventors: Joonas Paalasmaa, Helsinki (FI); Antti Sorvari, Itasalmi (FI); Alexander Kanavin, Helsinki (FI); Toni Strandell, Helsinki (FI)

Correspondence Address: HARRINGTON & SMITH, PC, 4 RESEARCH DRIVE, Suite 202, SHELTON, CT, 06484-6212, US

(21) Appl. No.: 12/308,971

(22) PCT Filed: Jun. 30, 2006
(86) PCT No.: PCT/IB2006/003496

§ 371 Date: Aug. 31, 2009

(51) Int. Cl. G06F 3/048

(52) U.S. Cl. 715/826; 715/810

(57) ABSTRACT

A method including: adding an entry having a first text part to a listing of content items, wherein if the content item satisfies a first criterion, the first text part of the entry has a first content and wherein if the content item does not satisfy the first criterion but satisfies a second criterion, the first text part of the entry has a second content, different to the first content.

### FIELD OF THE INVENTION

Embodiments of the present invention relate to a listing for received messages. In particular, they relate to methods, devices, computer programs and graphical user interfaces that provide a new listing for received messages.

### BACKGROUND TO THE INVENTION

User's of electronic devices are receiving an increasingly large number of messages such as emails, SMSs, MMSs etc.

Typically an electronic device provides a listing of received messages with one entry per message. An entry typically includes some information about the message such as whether it has been read, the date and time of receipt (or sending), the name or handle of the originator of the message and perhaps a subject line.

The information provided in an entry for a received message is not necessarily informative. A user may therefore have difficulty prioritizing messages using the listing and may open and read more messages that the user would like to determine their importance or relevance.

It would be desirable to provide a user with better information about received messages.

### BRIEF DESCRIPTION OF THE INVENTION

According to one embodiment of the invention there is provided a method comprising: adding an entry having a first text part to a listing of content items, wherein if the content item satisfies a first criterion, the first text part of the entry has a first content and wherein if the content item does not satisfy the first criterion but satisfies a second criterion, the first text part of the entry has a second content, different to the first content.

According to another embodiment of the invention there is provided a device comprising: a display operable to display a listing of content items that includes an entry having a first text part for a content item, wherein if the content item satisfies a first criterion, the first text part of the entry has a first content and if the content item does not satisfy the first criterion but satisfies a second criterion, the first text part of the entry has a second content, different to the first content.

According to another embodiment of the invention there is provided a computer program comprising computer program instructions which when loaded into a processor enables:

testing a content item against a first criterion;
if the content item satisfies the first criterion:
adapting a listing of content items to include an entry for the tested content item having first content in a first text part of the entry;
   if the content item does not satisfy the first criterion,
testing the content item against a second criterion; and
if the content item satisfies a second criterion:
   adapting the listing of messages to include an entry for the tested content item having second content, different to the first content, in the first text part of the entry.

According to another embodiment of the invention there is provided a graphical user interface comprising: a listing of content items that includes an entry having a first text part for a content item, wherein if the content item satisfies a first criterion, the first text part of the entry has a first content and if the received message does not satisfy the first criterion but satisfies a second criterion, the first text part of the entry has a second content, different to the first content.

According to a further embodiment of the invention there is provided a method comprising: receiving a message; and adding an entry having a first text part to a listing of received messages, wherein if the received message satisfies a first criterion on receipt, the first text part of the entry has a first content and wherein if the received message does not satisfy the first criterion but satisfies a second criterion on receipt, the first text part of the entry has a second content, different to the first content.

The information content provided to a user is therefore dynamic and changes depending upon the message received. The message listing may consequently be more informative to a user.

According to another embodiment of the invention there is provided an electronic device comprising: a receiver for receiving a message; and a display operable to display a listing of messages that includes an entry having a first text part for a received message, wherein if the received message satisfies a first criterion on receipt, the first text part of the entry has a first content and if the received message does not satisfy the first criterion but satisfies a second criterion on receipt, the first text part of the entry has a second content, different to the first content.

According to another embodiment of the invention there is provided a computer program comprising computer program instructions which when loaded into a processor enables: testing a received message against a first criterion; if the received message satisfies the first criterion: adapting a listing of messages to include an entry for the received message having first content in a first text part of the entry; if the received message does not satisfy the first criterion on receipt, testing the received message against a second criterion; and if the received message satisfies a second criterion: adapting the listing of messages to include an entry for the received message having second content, different to the first content, in the first text part of the entry.

According to another embodiment of the invention there is provided a graphical user interface comprising: a listing of messages that includes an entry having a first text part for a received message, wherein if the received message satisfies a first criterion on receipt, the first text part of the entry has a first content and if the received message does not satisfy the first criterion but satisfies a second criterion on receipt, the first text part of the entry has a second content, different to the first content.

According to another embodiment of the invention there is provided a method comprising: receiving a message having message metadata such as, for example, a header and a text body wherein the text body includes first text added to the text body by an originator of the message and at least other text that has not been added by the originator of the message; performing an extraction process that extracts only text that has been added to the text body of a message by an originator of the message to extract the first text that has been added to the text body by the originator of the message from the other text, included in the text body of the message, that has not been added by the originator of the message; and adding an entry to a listing of received messages, wherein the listing includes at least a portion of the first text.

### BRIEF DESCRIPTION OF THE DRAWINGS

For a better understanding of the present invention reference will now be made by way of example only to the accompanying drawings in which:

FIG. 1A illustrates a message;

FIG. 1B illustrates an example of a message body;

FIG. 2 illustrates a graphical user interface having a listing of received messages;

FIG. 3 illustrates a method for adding an entry to a listing when a message is received;

FIGS. 4, 5A and 5B illustrate examples of how a received message may be tested against different criteria and different content extracted; and

FIG. 6 schematically illustrates an electronic device.

### DETAILED DESCRIPTION OF EMBODIMENTS OF THE INVENTION

The Figures illustrate a method comprising: adding an entry having a first text part to a listing of content items, wherein if the content item satisfies a first criterion, the first text part of the entry has a first content and wherein if the content item does not satisfy the first criterion but satisfies a second criterion, the first text part of the entry has a second content, different to the first content. In the example illustrated, the content item is a received message however in other embodiments a content item may be a word processing document, a message, an images or a video, etc. A content item may, in some examples, be a data structure that stores information recorded or edited by a person.

FIG. 6 schematically illustrates an electronic device 50 that is operable to receive a message. The device 50 comprises a receiver 62 for receiving the message. The receiver may be any suitable mechanism that enables the receipt of a data structure representing the message. It may be, for example, a computer port or interface that uses a galvanic connection or a wireless interface such as a radio receiver or transceiver.

The electronic device 50 may be any device that is suitable for receiving a message and displaying a listing of received messages. Examples of electronic devices include, but are not limited to: mobile cellular telephones, computer workstations, personal digital assistants, personal entertainment consoles such as a music player and/or game player and/or video player etc

The device 50 also comprises a processor 52, a memory 54, a display 58 and a user input mechanism 60. The processor 52 is arranged to read from and write to the memory 54, receive inputs from the receiver 62 and the user input mechanism 60 and provide outputs to the display 58.

The display 58 may be any suitable device for providing a visual output. It may for example be a display screen such as an LCD display or similar.

The user input 60 may be any suitable mechanism that enables a user to provide one or more input commands to the device 50. It may for example be a sensor, or an audio input device or an actuator such as a button, keypad or touch screen. The user input mechanism 60, if a touch screen, may be integrated with the display 58.

The memory 54 stores computer program instructions 56 that control the operation of the electronic device 50 when loaded into the processor 52. The computer program instructions 56 provide the logic and routines that enables the electronic device to perform the methods illustrated in FIGS. 3, 4 and 5.

The computer program instructions may arrive at the electronic device 50 via an electromagnetic carrier signal or be copied from a physical entity 70 such as a computer program product, a memory device or a record medium such as a CD-ROM or DVD.

Although the device 50 is illustrated as a single processor device, it should be appreciated that additional processors may be used. Furthermore, it should be appreciated that only the minimum number of functional components are illustrated and actual implementations of the invention may have different components. For example, although a programmable processor 52 and associated memory 54 are illustrated, in some implementations they may be replaced by dedicated circuitry such as an application specific integrated circuit or similar.

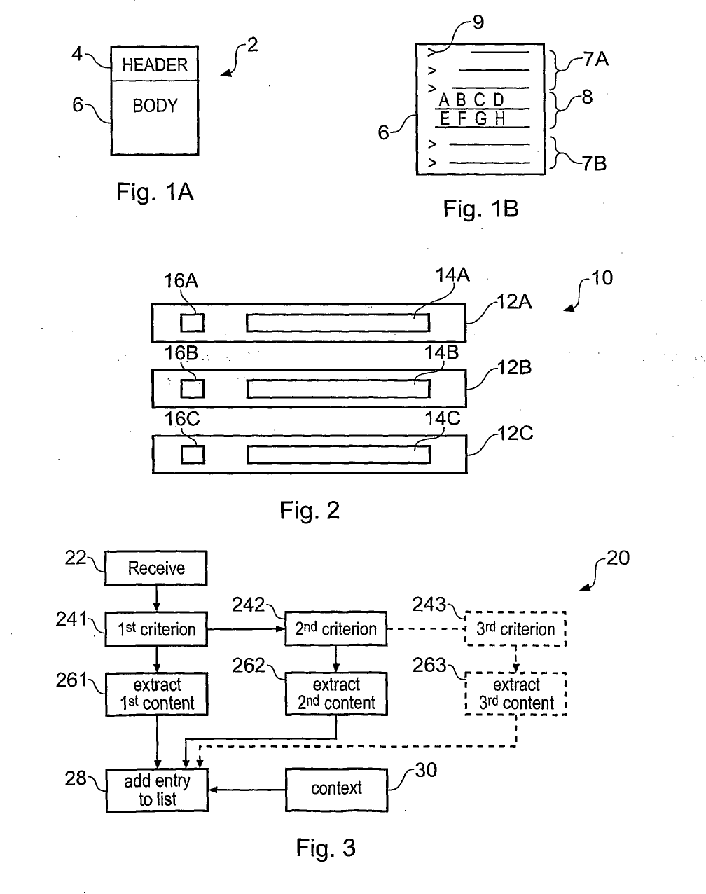

FIG. 1A illustrates a message 2 that is used to convey information between a message source and a message destination such as electronic device 50. The message 2 may be, for example, an email, a Short Message Service (SMS) message, a Multimedia Message Service (MMS) message etc.

The message 2 comprises a header portion 4 and a body portion 6. The header portion 4 is typically used to route the message from the source to its destination and typically includes information such as source address, destination address, message subject etc

The body portion 6 may typically include text. The message may also comprise an ‘attached’ file. Such a file may be included in the header 4 or the body 6 depending upon implementation.

FIG. 1B illustrates a body 6 of a message 2 that includes a ‘thread’. A ‘thread’ is a messaging dialogue involving at least two parties and the dialogue is recorded within the message. The body portion 6 includes text 8 that was added to the body 6 by an originator of the message 2 at the message source and also text 7 that was included in the body 6 of a message received at the source and then edited by the originator of the message 2 to include new text 8 before the message was sent to the destination. The non-original text is typically differentiated from the newly added text by prefacing the non-original text with at least one ‘>’ textual marker 9 while not prefacing the newly added text with such a sign. However, other markers may be used such as different font color for different contributors to the dialogue.

FIG. 2 illustrates a graphical user interface having a listing 10 of received messages 2 and displayed in the display 58 of the receiving device 50. The listing 10 comprises a plurality of entries 12A, 12B, 12C which are respectively associated with different separately received messages 2. The listing 10 is used to identify to a user of the receiving device 50 the relevance of the received messages and may be used to access a particular message 2 by selecting an entry in the listing that is associated with that particular message 2.

An entry 12 comprises a text part 14 that is located in a standard position for all entries. An entry may also comprise additional information 16.

If a received message 2 satisfies a first criterion on receipt, its corresponding entry 12 is created in the listing 10 with a first content, in the text part 14, which has been extracted from the received message 2 using a first extraction process.

If a received message 2 alternatively satisfies a second criterion on receipt, its corresponding entry 12 is created in the listing 10 with a second content, in the text part 14, which has been extracted from the message using a second extraction process, different to the first extraction process.

An entry 12 may be highlighted to draw it to the user's attention. Such highlighting may involve the use of markers, colored fonts, audio alerts etc. For example, an entry 12 in the listing 10 may be highlighted if the originator of the received message 2 satisfies a predetermined contextual condition when the message is received. One suitable predetermined condition is that there is an on-going active communication, such as a telephone call, between the originator of the received message and the receiving device 50. Another suitable predetermined condition is that there has been within a certain time period communication between the originator of the received message and the receiving device 50: Communication may include one or more of a telephone call, message, receipt, message sending etc. A further suitable predetermined condition is that the originator of the received message is local to the receiving device 50. That is, the originator of the received message 2 is within a certain distance of the receiving device 50.

FIG. 3 illustrates a method for adding an entry 12 to a listing 10 when a message 2 is received.

At block 22, a message 2 is received at the device 50.

At block 241, the received message 2 is tested against a first criterion. If the received message 2 passes this first test the method moves to block 261. However, if the received message fails this first test, the method moves to block 242.

At block 242, the received message is tested against a second criterion. If the received message 2 passes this second test, the method moves to block 262. However, if the received message 2 fails this second test, the method moves to block 243, if present.

At block 243, if present, the received message 2 is tested against a third criterion. If the received message passes this third test, the method moves to block 263. However, if the received message fails this third test, the method moves to block 244, if present.

At block 261 first content is extracted from the received message 2.

At block 262 second content is extracted from the received message 2.

At block 263 third content is extracted from the received message 2.

After extracting content at one of blocks 26n, where n=1, 2, 3 . . . , the method moves to block 28, where an entry 12 is added to the listing 10. The extracted content is used to create the text part 14 of a new entry 12 in the listing 10 for the newly received message 2.

At block 28, a context of the device 50 may be used to adapt the new entry 12, for example, by highlighting as described previously with reference to FIG. 2.

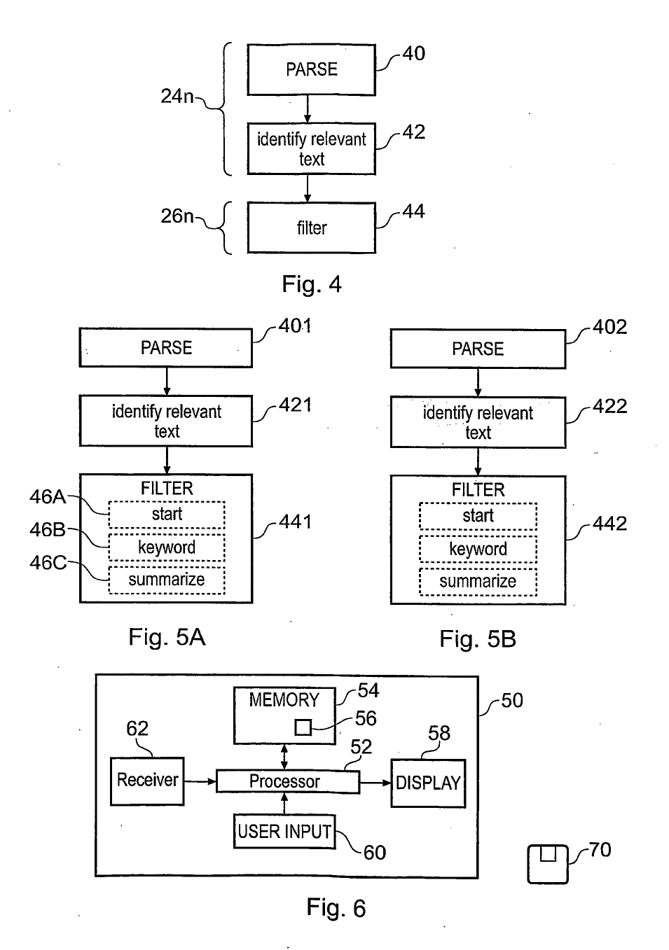

FIGS. 4, 5A and 5B illustrate examples of how a received message may be tested against different criteria and different content extracted.

Referring to FIG. 4, at block 40, the received message is parsed into component parts. This process enables a receiving device 50 to identify specific parts of the received message 2.

Next at step 42, relevant text is identified within the parsed message. The presence of relevant text corresponds to a criterion tested at a block 24n in FIG. 3 where the definition of ‘relevant’ changes for each value of n.

Next at block 44, the identified relevant text is filtered to extract text for use in the text part 14 of the entry 12 in the listing 10 for the received message 2.

FIG. 5A illustrates a particular example, which is suitable for use when n=1 however it may alternatively be used when n has other values.

At block 40n, the body 6 of the received message is parsed into component parts. This process enables a device to identify specific parts of the received message 2.

The parsing block 40n delimits ‘original’ text, which has been newly added to the body 6 of the received message 2 by the originator of the received message 2, from non-original text, which is text that was not added to the body 6 of the received message by the originator of the message. For example, referring back to the threaded email example of FIG. 1B, the relevant text is original text 8 not the non-original text 7. The delimiting of the original text from non-original text may, for example, be achieved using the marker ‘>’ 9 that identifies non-original text. In other embodiments, the color of the text may indicate the author and markers 9 are not required.

Although a single portion of original text 8 is illustrated in FIG. 1B, it should be appreciated that the original text may be in multiple portions separated by non-original text 7.

Next at step 42n, relevant text is identified within the parsed message. The presence of relevant text corresponds to a criterion tested at a block 24n in FIG. 3. In this example, ‘relevant’ text is ‘original’ text that has been newly added to the body 6 of the received message 2 by the originator of the message. This text may be identified, for example, because it does not include markers 9. However, in other examples the ‘relevant’ text may be text that the recipient of the message has not viewed yet.

Next at block 44n, the relevant text is filtered to extract text for use in the text part 14 of the entry 12 for the received message 2. For example, referring back to FIG. 1B, the relevant text ABCDEFG may be filtered to BCF.

Thus content may be created by selecting words from the relevant text using a filter. A single filter may be used or one of a plurality of filters may be dynamically selected for use. A filter may be fixed or dynamically variable.

One suitable type of filter 46A, selects a start portion (e.g. the first N words) of the relevant text.

Another suitable type of filter 46B, identifies keywords within the relevant text and uses the identified keywords in the order they occur in the relevant text as the content. The keywords may be dynamically updated by the device 50.

Another suitable type of filter 46C, summarizes the relevant text.

The extracted content may be located within a body of text and in this case non-original text that precedes or follows the original text is not extracted. A selective extraction process occurs in which only original text is extracted.

FIG. 5B illustrates a particular example, which is suitable for use when n=2 however it may alternatively be used when n has other values.

At block 40n, the received message is parsed into component parts. This process enables a device to identify specific parts of the message.

The parsing block 40n delimits any attachments included in the message and the text associated with the attachments.

Next at step 42n, relevant text is identified within the parsed message. The presence of relevant text corresponds to a criterion tested at a block 24n in FIG. 3. In this example, ‘relevant’ text is text that is associated with an attachment.

Next at block 44, the relevant text is filtered to extract text for use in the text part 14 of the entry 12 for the received message 2. Similar filters to those described with reference to FIG. 5A may be used.

Although embodiments of the present invention have been described in the preceding paragraphs with reference to various examples, it should be appreciated that modifications to the examples given can be made without departing from the scope of the invention as claimed. For example, although an embodiment of the invention has been described with reference to a listing of received messages, other embodiments of the invention may relate to listings of other content items such as word processing documents, messages, images, videos, etc.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
adding an entry having a first text part to a listing of content items, wherein if the content item satisfies a first criterion, the first text part of the entry has a first content and wherein if the content item does not satisfy the first criterion but satisfies a second criterion, the first text part of the entry has a second content, different to the first content and presenting the listing.

2. A method as claimed in claim 1, wherein the first text part of the entry is located in the same position within the entry irrespective of whether it has the first content or the second content.

3. A method as claimed in claim 1, wherein the first text part of the entry comprises text extracted from the content item.

4. A method as claimed in claim 1, wherein the first content differs from the second content in that the first content is created from a first portion of the content item whereas the second content is created from a second, different, portion of the content item.

5. A method as claimed in claim 4, wherein one of the first portion of the content item or the second portion of the content item, but not the first and second portions of the content item, is a start portion of a body of the content item.

6. A method as claimed in claim 4, wherein the first portion of the content item and/or the second portion of the content item is a portion of the content item that was newly added by an author of the content item.

7. A method as claimed in claim 4, wherein the first portion of the content item and/or the second portion of the content item is a portion of text from a body of a received message that was newly added by an originator of the message.

8. A method as claimed in claim 4, wherein the first portion of the content item and/or the second portion of the content item is a portion of the content item that has not yet been viewed.

9. A method as claimed in claim 1, wherein the first content and/or second content is created by selecting words from the content item using a first filter.

10. A method as claimed in claim 9, wherein the first filter extracts first keywords from text to form the first content.

11. A method as claimed in claim 10, wherein the first filter summarizes text.

12. (canceled)

13. (canceled)

14. (canceled)

15. A method as claimed in claim 1, wherein the first content and/or the second content is a portion of a received message associated with an attachment included in the received message.

16. A method as claimed in claim 1, wherein the first content comprises text newly added to a body of a received message by an originator of the received message, and the second content is a portion of a received message associated with an attachment included in the received message.

17. A method as claimed in claim 1, wherein the second content is used only when there is no first content available.

18. A method as claimed in claim 1, wherein the content item is a received message comprising a header and a text body that includes first text added to the text body by an originator of the message and at least other text that has not been added by the originator of the message, the method further comprising:
performing an extraction process that extracts only text that has been added to the text body of a received message by an originator of the message to extract first text that has been added to the text body by the originator of the message- from other text, included in the text body of the message, that has not been added by the originator of the message; and
creating content using the first text.

19. A method as claimed in claim 1 further comprising highlighting an entry in the listing if an author of the content item satisfies a predetermined condition.

20. (canceled)

21. An electronic device comprising:
a display configured to display a listing of content items that includes an entry having a first text part for a content item, wherein if the content item satisfies a first criterion, the first text part of the entry has a first content and if the content item does not satisfy the first criterion but satisfies a second criterion, the first text part of the entry has a second content, different to the first content.

22. A device as claimed in claim 21 further comprising an extraction mechanism that is configured to selectively extract text from a content item to fill the first text part of the entry.

23. A device as claimed in claim 22, wherein the extraction mechanism is configured to extracts the first content from a first portion of the content item and the second content from a second, different, portion of the content item.

24. A device as claimed in claim 23, wherein the first portion of the content item is a portion of the message that was newly added by an author of the content item.

25. A device as claimed in claim 22, wherein the extraction mechanism includes a filter for filtering text from a content item to create content for use in the first text part of the entry.

26. A device as claimed in claim 21, wherein the first content and/or the second content is a portion of a received message associated with an attachment included in the received message.

27. A device as claimed in claim 21, wherein the first portion of the content item and/or the second portion of the content item is a portion of the content item that has not yet been viewed using the device.

28. A device as claimed in claim 21, wherein the second content is used only when there is no first content available.

29. A device as claimed in claim 21, wherein the content item is a message, the device further comprising a receiver configured to receive the message.

30. A computer program comprising computer program instructions which when loaded into a processor enable the method of claim 1.

31. A computer program comprising computer program instructions which when loaded into a processor enables:
testing a content item against a first criterion;
if the content item satisfies the first criterion:
adapting a listing of content items to include an entry for the tested content item having first content in a first text part of the entry;
if the content item does not satisfy the first criterion,
testing the content item against a second criterion; and
if the content item satisfies a second criterion:
adapting the listing of messages to include an entry for the tested content item having second content, different to the first content, in the first text part of the entry.

32. A computer program as claimed in claim 31 that further enables first selective extraction of text from the content item to create the first content and second selective extraction of text from the received message to create the second content.

33. A computer program as claimed in claim 32, wherein the first selective extraction extracts text from a first portion of the content item but not from a second portion of the content item and the second selective extraction extracts text from the second portion of the content item but not from the first portion of the content item.

34. A computer program as claimed in claim 33, wherein the first portion of the content item is a portion of a received message that was newly added by an originator of the message.

35. A computer program as claimed in claim 34, wherein the second portion of the message is a portion of the message that is associated with an attachment to the message.

36. A computer program as claimed in claim 31 that further enables filtering text from a content item to create content for use in the first text part of the entry.

37. A physical entity embodying the computer program as claimed in claim 30.

38. A graphical user interface comprising:
a listing of content items that includes an entry having a first text part for a content item, wherein if the content item satisfies a first criterion, the first text part of the entry has a first content and if the received message does not satisfy the first criterion but satisfies a second criterion, the first text part of the entry has a second content, different to the first content.

39. A method comprising:
receiving a message having a header and a text body wherein the text body includes first text added to the text body by an originator of the message and at least other text that has not been added by the originator of the message;
performing an extraction process that extracts only text that has been added to the text body of a message by an originator of the message to extract the first text that has been added to the text body by the originator of the message from the other text, included in the text body of the message, that has not been added by the originator of the message; and
adding an entry to a listing of received messages, wherein the listing includes at least a portion of the first text.
